(19) United States
(12) Patent Application Publication
(10) Pub. No.: US 2024/0313259 A1
(43) Pub. Date: Sep. 19, 2024

(54) SOLID ELECTROLYTE LAYER AND ALL-SOLID-STATE BATTERY

(71) Applicant: TDK CORPORATION, Tokyo (JP)

(72) Inventors: Taisuke MASUKO, Tokyo (JP); Tomoko NAKAMURA, Tokyo (JP); Keiko TAKEUCHI, Tokyo (JP)

(73) Assignee: TDK CORPORATION, Tokyo (JP)

(21) Appl. No.: 18/272,504

(22) PCT Filed: Feb. 10, 2022
(86) PCT No.: PCT/JP2022/005392

§ 371 Date: Jul. 14, 2023

(30) Foreign Application Priority Data
Feb. 12, 2021 (JP) 2021-020431

(51) Int. Cl. H01M 10/0562; H01M 4/04; H01M 10/0525

(52) U.S. Cl. CPC H01M 10/0562; H01M 4/0407; H01M 10/0525; H01M 2300/0068

(57) ABSTRACT

A solid electrolyte layer contains a first compound represented by LiₐM₂(PO₄)₃ . . . (1) and a second compound represented by M′P₂O₇ . . . (2), and an abundance ratio of the second compound is 0.5 volume % or more and less than 10 volume %.

### TECHNICAL FIELD

The present invention relates to a solid electrolyte layer and an all-solid-state battery.

Priority is claimed on Japanese Patent Application No. 2021-020431, filed Feb. 12, 2021, the content of which is incorporated herein by reference.

### BACKGROUND ART

In recent years, electronics technology has been significantly developed, and the size reduction, weight reduction, thickness reduction and multi-functionalization of mobile electronic devices have been achieved. Accordingly, for batteries that serve as power sources of electronic devices, there has been a strong demand for size reduction, weight reduction, thickness reduction and reliability improvement, and all-solid-state batteries in which a solid electrolyte is used as an electrolyte have been gaining attention.

For example, Patent Document 1 describes an all-solid-state battery in which Li_{1.3}Al_{0.3}Ti_{1.7}(PO₄)₃ is used as a solid electrolyte. In addition, Patent Document 2 describes LiZr₂(PO₄)₃ containing Zr, which is superior to the solid electrolyte disclosed in Patent Document 1 in terms of reduction resistance. In addition, Patent Document 3 describes an all-solid-state battery in which a solid electrolyte obtained by substituting some of Zr in LiZr₂(PO₄)₃ with a different element is used. When some of Zr in LiZr₂(PO₄)₃ is substituted with a different element, a crystal phase becomes stable, and the discharge capacity becomes large.

### CITATION LIST

### Patent Document

### [Patent Document 1]

Japanese Unexamined Patent Application, First Publication No. 2016-1595

### [Patent Document 2]

Japanese Unexamined Patent Application, First Publication No. 2001-143754

### [Patent Document 3]

Japanese Unexamined Patent Application, First Publication No. 2015-65022

### SUMMARY OF INVENTION

### Technical Problem

However, for example, LiZr₂(PO₄)₃ described in Patent Document 2 has poor sinterability when sintered, making it difficult to produce high-density solid electrolyte layers. As a result, there are cases where moisture or the like intrudes into gaps between solid electrolytes and the cycle characteristics under high-temperature and high-humidity environments are not sufficient.

The present invention has been made in consideration of the above-described problem, and an objective of the present disclosure is to provide a solid electrolyte layer and an all-solid-state battery being excellent in terms of cycle characteristic under high-temperature and high-humidity environments.

### Solution to Problem

In order to solve the above-described problem, the following means is provided.

(1) A solid electrolyte layer according to a first aspect contains a first compound represented by LiₐM₂(PO₄)₃ . . . (1) and a second compound represented by M′P₂O₇ . . . (2), in the first compound, a satisfies 0.9≤a≤1.4, M is one or more elements selected from the group consisting of Zr, Ti, Ge, Al, Hf, Ca, Ba, Sr, Sc, Y and In, in the second compound, M′ is one or more elements selected from the group consisting of Zr, Ti, Ge, Al, Hf, Ca, Ba, Sr, Sc, Y and In, and an abundance ratio of the second compound is 0.5 volume % or more and less than 10 volume %.

(2) In the solid electrolyte layer according to the above-described aspect, an average grain diameter Da of the first compound and an average grain diameter Db of the second compound may satisfy 0.1≤Da/Db≤20.0.

(3) In the solid electrolyte layer according to the above-described aspect, the average grain diameter Db of the second compound may satisfy 0.01 m≤Db≤10 μm.

(4) An all-solid-state battery according to a second aspect includes the solid electrolyte layer according to the above-described aspect, a positive electrode and a negative electrode that sandwich the solid electrolyte layer.

### Advantageous Effects of Invention

An all-solid-state battery in which the solid electrolyte layer according to the above-described aspect is used has an excellent cycle characteristic under high-temperature and high-humidity environments.

### BRIEF DESCRIPTION OF DRAWINGS

FIG. 1 is a schematic cross-sectional view of an all-solid-state battery according to the present embodiment.

FIG. 2 is a schematic cross-sectional view of a solid electrolyte layer according to the present embodiment.

### DESCRIPTION OF EMBODIMENTS

Hereinafter, the present embodiment will be described in detail with appropriate reference to drawings. In the drawings to be used in the following description, there will be cases where a characteristic portion is shown in an enlarged manner for convenience in order to facilitate the understanding of the characteristics of the present invention, and the dimensional proportion or the like of each configurational element is different from actual one in some cases. Materials, dimensions and the like to be provided as exemplary examples in the following description are simply examples, and the present invention is not limited thereto and can be appropriately modified and carried out within the scope of the gist of the present invention.

### [All-Solid-State Battery]

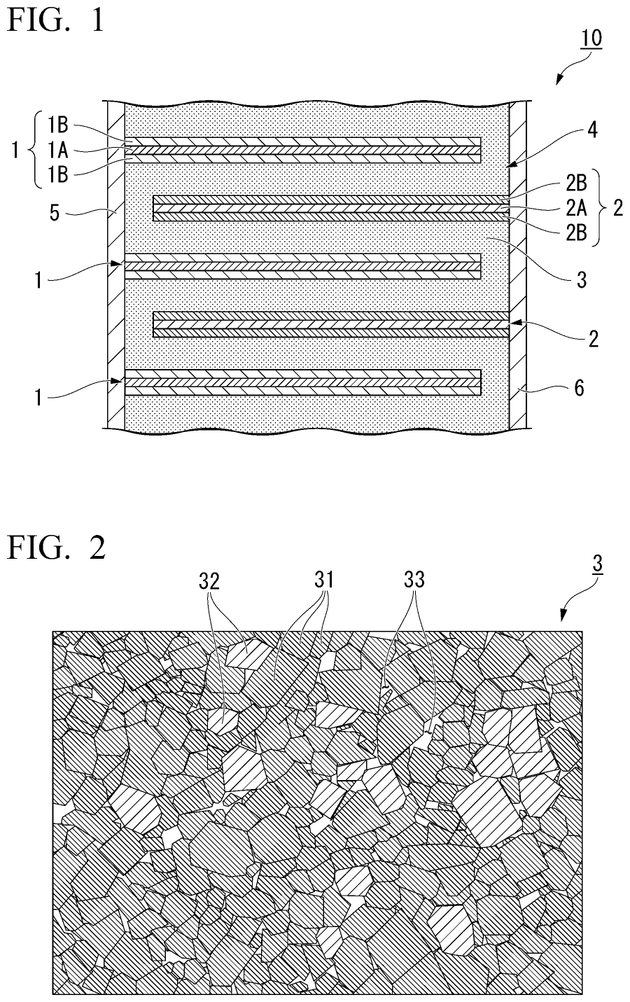

FIG. 1 is a schematic cross-sectional view of an all-solid-state battery 10 according to the present embodiment. The all-solid-state battery 10 has a laminate 4 and terminal electrodes 5 and 6. The terminal electrodes 5 and 6 are each in contact with a facing surface of the laminate 4. The terminal electrodes 5 and 6 extend in a direction intersecting with (perpendicular to) the lamination surface of the laminate 4.

The laminate 4 has positive electrodes 1, negative electrodes 2 and a solid electrolyte layer 3. The numbers of layers of the positive electrodes 1 and the negative electrodes 2 do not matter. The solid electrolyte layer 3 is present between the positive electrode 1 and the negative electrode 2, between the positive electrode 1 and the terminal electrode 6 and between the negative electrode 2 and the terminal electrode 5. The positive electrodes 1 are each connected to the terminal electrode 5 at one end. The negative electrodes 2 are each connected to the terminal electrode 6 at one end.

The all-solid-state battery 10 is charged or discharged by the transfer of ions between the positive electrodes 1 and the negative electrodes 2 through the solid electrolyte layer 3. In FIG. 1, a laminated battery is shown, but the all-solid-state battery may be a wound battery. The all-solid-state battery 10 is used in, for example, laminated batteries, square batteries, cylindrical batteries, coin-like batteries, button-like batteries and the like. In addition, the all-solid-state battery 10 may be an injection-type battery including the solid electrolyte layer 3 dissolved or dispersed in a solvent.

“Solid electrolyte layer” The solid electrolyte layer 3 is a substance capable of migrating ions with an electric field applied from the outside. For example, the solid electrolyte layer 3 conducts lithium ions and impairs the migration of electrons. The solid electrolyte layer 3 is, for example, a sintered body obtained by sintering.

FIG. 2 is a schematic cross-sectional view of the solid electrolyte layer 3 according to the present embodiment. The solid electrolyte layer 3 has a first compound 31 and a second compound 32. There are cavities 33 between the first compound 31 and the second compound 32, between the first compounds 31 and between the second compounds 32. The solid electrolyte layer 3 may contain a substance other than the first compound 31 and the second compound 32. For example, the solid electrolyte layer 3 may contain a binder.

The first compound 31 is a solid electrolyte represented by LiₐM₂(PO₄)₃ . . . (1). In the composition formula, a satisfies 0.9≤a≤1.4. a is basically 1.0, that is, preferably 1.0 with some deviation permitted. In the composition formula, M is one or more elements selected from the group consisting of Zr, Ti, Ge, Al, Hf, Ca, Ba, Sr, Sc, Y and In. M is elements that have been confirmed to be substitutable with each other. It has been confirmed that, even when the element is changed, the sinterability of the solid electrolyte layer 3 remains the same by the selection of an appropriate sintering temperature, the selection of an appropriate sintering aid, the adjustment of the amount of the sintering aid or the like. The first compound 31 is, for example, LiₐZr₂(PO₄)₃, LiₐTi₂(PO₄)₃ or LiₐZr_{1.5}Ti_{0.5}(PO₄)₃.

The second compound 32 is a compound represented by M′P₂O₇ . . . (2). In the composition formula, M′ is one or more elements selected from the group consisting of Zr, Ti, Ge, Al, Hf, Ca, Ba, Sr, Sc, Y and In. M′ is elements that have been confirmed to be substitutable with each other. It has been confirmed that, even when the element is changed, the physical properties (crystallinity, size and the like) of the second compound 32 do not significantly change by adjusting the synthesis conditions (raw material grain diameters, synthesis temperature and the like) of the second compound 32. M′ may be the same as M in the composition formula (1). The second compound 32 is, for example, ZrP₂P₇ or TiP₂O₇.

When the total volume of the solid electrolyte layer excluding the cavities is set to 100%, the proportion of the total volume of the second compound that is contained in the solid electrolyte layer 3, that is, the abundance ratio of the second compound 32 is 0.5 volume % or more and less than 10.0 volume %. The abundance ratio of the second compound 32 that is contained in the solid electrolyte layer 3 is preferably 2.0 volume % or more and 8.0 volume % or less, more preferably 2.0 volume % or more and 5.0 volume % or less and still more preferably 3.0 volume % or more and 4.0 volume % or less.

In addition, the proportion of the total volume of all of the first compound that is contained in the solid electrolyte layer 3, that is, the abundance ratio of the first compound 31 is 90 volume % or more and less than 99.5 volume %, preferably 92 volume % or more and 99 volume % or less, more preferably 95 volume % or more and 98 volume % or less and still more preferably 96 volume % or more and 97 volume % or less.

When the abundance ratio of the second compound 32 that is contained in the solid electrolyte layer 3 is small, sinterabilty during sintering cannot be sufficiently obtained, and the number of the cavities 33 becomes large. Moisture or the like is likely to intrude into the cavities 33, which becomes a cause for the deterioration of the solid electrolyte layer 3. As a result, the cycle characteristic of the all-solid-state battery 10 at high temperatures and high humidity deteriorates. In contrast, the second compound 32 has a relatively lower ion conductivity than the first compound 31. Therefore, when the abundance ratio of the second compound 32 that is contained in the solid electrolyte layer 3 is large, the cycle characteristic at high temperatures and high humidity deteriorates.

In addition, the average grain diameter Da of the first compound 31 and the average grain diameter Db of the second compound 32 preferably satisfy 0.1≤Da/Db≤20.0, more preferably satisfy 0.1≤Da/Db≤10.0, still more preferably satisfy 0.5<Da/Db≤5.0 and particularly preferably satisfy 0.1≤Da/Db≤3.0. When the average grain diameters Da and Db satisfy the above-described relationship, the sinterability of the solid electrolyte layer 3 improves, and the number of the cavities 33 becomes small. As a result, the cycle characteristic of the all-solid-state battery 10 at high temperatures and high humidity improves. Here, the average grain diameters Da and Db are obtained as described below.

First, a cross section of the solid electrolyte layer 3 is cut out, and a backscattered electron compositional image of a smooth cross section that has appeared by processing with a cross section polisher (CP) is observed with a scanning electron microscope (SEM). The observation may be carried out at a magnification of, for example, approximately 10000 times. As an observation region, for example, a 5 μm×5 μm-size square region is an exemplary example. On an observation image obtained at this time, the first compound 31 and the second compound 32 are differentiated due to a difference in contrast. In this case, portions with a relatively bright contrast are differentiated as the first compound, and dark portions are differentiated as the second compound. The first compound (LiₐM₂(PO₄)₃) contains a large amount of the element M having a large atomic number compared with the second compound (M′P₂O₇) and is thus observed relatively brightly and can be differentiated. In addition, it is also possible to confirm the compositions of the first compound 31 and the second compound 32 using energy-dispersive X-ray spectroscopy (EDS) and differentiate the compounds. In a case where no clear difference in contrast is shown, the first compound 31 and the second compound 32 can be differentiated with an X-ray mapping image acquired by EDS.

After that, the average grain diameter Da of the first compound 31 and the average grain diameter Db of the second compound 32 are measured.

Specifically, the average grain diameters Da and Db are obtained by measuring, if possible, the longest major axes of all of the first compound 31 and the second compound 32 in the observed visual field and obtaining the average values thereof.

The average grain diameter Da of the first compound 31 is, for example, preferably 0.5 μm or more and 10 μm or less. The average grain diameter Db of the second compound 32 is, for example, preferably 0.01 μm or more and 10 μm or less, more preferably 0.1 μm or more and 2.0 μm or less and still more preferably 0.3 μm or more and 1.0 μm or less.

### “Positive Electrode”

As shown in FIG. 1, the positive electrode 1 has, for example, a positive electrode current collector 1A and positive electrode active material layers 1B containing a positive electrode active material.

### (Positive Electrode Current Collector)

The positive electrode current collector 1A is highly conductive. The positive electrode current collector 1A is, for example, a metal such as silver, palladium, gold, platinum, aluminum, copper, nickel, stainless steel or iron, an alloy thereof, a conductive resin or the like. The positive electrode current collector 1A may have any of a powder form, a foil form, a punched form and an expanded form.

### (Positive Electrode Active Material Layer)

The positive electrode active material layer 1B is formed on one surface or both surfaces of the positive electrode current collector 1A. The positive electrode active material layer 1B contains a positive electrode active material. The positive electrode active material layer 1B may contain a conductive auxiliary agent, a binder and the above-described solid electrolyte.

### (Positive Electrode Active Material)

The positive electrode active material is not particularly limited as long as the positive electrode active material is capable of reversibly progressing the emission and absorption of lithium ions and the deintercalation and intercalation of lithium ions. For example, as the positive electrode active material, it is possible to use well-known positive electrode active materials that are used in lithium-ion secondary batteries.

The positive electrode active material is, for example, a composite transition metal oxide, a transition metal fluoride, a polyanion, a transition metal sulfide, a transition metal oxyfluoride, a transition metal oxysulfide or a transition metal oxynitride.

Examples of the positive electrode active material include lithium cobalt oxide (LiCoO₂), lithium nickel oxide (LiNiO₂), lithium manganese spinel (LiMn₂O₄), a composite metal oxide represented by a general formula: LiNiₓCo_{y}Mn_{z}MₐO₂(x+y+z+a=1, 0≤x≤1, 0≤y≤1, 0≤z≤1, 0≤a≤1 and M is one or more elements selected from the group consisting of Al, Mg, Nb, Ti, Cu, Zn and Cr), a lithium vanadium compound (LiV₂O₅, Li₃V₂(PO₄)₃ or LiVOPO₄), olivine-type LiMPO₄ (here, M represents one or more elements selected from the group consisting of Co, Ni, Mn, Fe, Mg, V, Nb, Ti, Al and Zr), lithium titanate (Li₄Ti₅O₁₂), LiaNiₓCo_{y}Al_{z}O₂ (0.9<x+y+z<1.1) and the like.

In addition, as the positive electrode active material, positive electrode active materials containing no lithium can also be used. These positive electrode active materials can be used by disposing a metallic lithium or lithium ion-doped negative electrode active material in the negative electrode in advance and discharging the battery in the beginning. For example, metal oxides containing no lithium (MnO₂, V₂O₅ and the like), metal sulfides containing no lithium (MoS₂ and the like), fluorides containing no lithium (FeF₃, VF₃ and the like) and the like are examples of these positive electrode active materials.

### (Conductive Auxiliary Agent)

The conductive auxiliary agent is not particularly limited as long as the conductive auxiliary agent improves electron conductivity in the positive electrode active material layer 1B, and well-known conductive auxiliary agents can be used. Examples of the conductive auxiliary agent include carbon-based materials such as graphite, carbon black, graphene and carbon nanotubes, metals such as gold, platinum, silver, palladium, aluminum, copper, nickel, stainless steel and iron, conductive oxides such as ITO and mixtures thereof. The conductive auxiliary agent may have each of a powder form and a fiber form.

### (Binder)

The binder joins the positive electrode current collector 1A and the positive electrode active material layer 1B, the positive electrode active material layer 1B and the solid electrolyte layer 3 and a variety of materials that configure the positive electrode active material layer 1B.

The binder can be used to an extent that the function of the positive electrode active material layer 1B is not lost. The binder may not be contained if not necessary. The amount of the binder in the positive electrode active material layer 1B is, for example, 0.5 to 30 volume % of the positive electrode active material layer. When the amount of the binder is sufficiently small, the resistance of the positive electrode active material layer 1B becomes sufficiently low.

The binder needs to be capable of the above-described joint, and examples thereof include fluororesins such as polyvinylidene fluoride (PVDF) and polytetrafluoroethylene (PTFE). Furthermore, aside from what has been described above, as the binder, for example, cellulose, styrene/butadiene rubber, ethylene/propylene rubber, a polyimide resin, a polyamide-imide resin or the like may also be used. In addition, as the binder, a conductive polymer having electron conductivity or an ion-conductive polymer having ion conductivity may also be used. As the conductive polymer having electron conductivity, for example, polyacetylene or the like is an exemplary example. In this case, the binder also exhibits the function of conductive auxiliary agent particles, and thus the conductive auxiliary agent may not be added. As the ion-conductive polymer having ion conductivity, for example, polymers that conduct lithium ions or the like can be used, and polymers obtained by compositing a monomer of a polymer compound (a polyether-based polymer compound such as polyethylene oxide or polypropylene oxide, polyphosphazene or the like) and a lithium salt such as LiClO₄, LiBF₄ or LiPF₆ or an alkali metal salt mainly containing lithium and the like are exemplary examples. As a polymerization initiator that is used to composite the monomer and the lithium salt or the alkali metal salt, for example, a photopolymerization initiator, a thermal polymerization initiator or the like suitable for the monomer is an exemplary example. Examples of characteristics that are required for the binder include oxidation/reduction resistance and favorable adhesiveness.

### (Solid Electrolyte)

A solid electrolyte that is contained in the positive electrode active material layer 1B improves ion conduction in the positive electrode active material layer 1B. The solid electrolyte is the same as the above-described solid electrolyte that is contained in the solid electrolyte layer 3.

### “Negative Electrode”

As shown in FIG. 1, the negative electrode 2 has, for example, a negative electrode current collector 2A and negative electrode active material layers 2B containing a negative electrode active material.

### (Negative Electrode Current Collector)

The negative electrode current collector 2A is the same as the positive electrode current collector 1A.

### (Negative Electrode Active Material Layer)

The negative electrode active material layer 2B is formed on one surface or both surfaces of the negative electrode current collector 2A. The negative electrode active material layer 2B contains a negative electrode active material. The negative electrode active material layer 2B may contain a conductive auxiliary agent, a binder and the above-described solid electrolyte.

### (Negative Electrode Active Material)

The negative electrode active material is a compound capable of absorbing and emitting ions. The negative electrode active material is a compound exhibiting a lower potential than the positive electrode active material. As the negative electrode active material, it is possible to use the same material as the positive electrode active material. The negative electrode active material and the positive electrode active material that are used in the all-solid-state battery 10 are determined in consideration of the potentials of the negative electrode active material and the potential of the positive electrode active material.

### (Conductive Auxiliary Agent)

The conductive auxiliary agent improves the electron conductivity of the negative electrode active material layer 2B. As the conductive auxiliary agent, it is possible to use the same material as in the positive electrode active material layer 1B.

### (Binder)

The binder joins the negative electrode current collector 2A and the negative electrode active material layer 2B, the negative electrode active material layer 2B and the solid electrolyte layer 3 and a variety of materials that configure the negative electrode active material layer 2B. As the binder, it is possible to use the same material as in the positive electrode active material layer 1B. The content proportion of the binder can be the same as that in the positive electrode active material layer 1B. The binder may not be contained if not necessary.

### (Solid Electrolyte)

A solid electrolyte that is contained in the negative electrode active material layer 2B improves ion conduction in the negative electrode active material layer 2B. The solid electrolyte is the same as the above-described solid electrolyte that is contained in the solid electrolyte layer 3.

At least one of the positive electrode active material layer 1B, the negative electrode active material layer 2B and the solid electrolyte layer 3 may contain a non-aqueous electrolytic solution, an ionic liquid and a gel electrolyte. When these substances are contained in any of the above-described layers, a rate characteristic, which is one battery characteristic, improves.

(Method for Manufacturing of all-Solid-State Battery)

Next, a method for manufacturing the all-solid-state battery 10 will be described. First, the laminate 4 is produced. The laminate 4 is produced by, for example, a simultaneous firing method or a sequential firing method.

The simultaneous firing method is a method in which materials that form individual layers are laminated and then collectively fired to produce the laminate 4. The sequential firing method is a method in which firing is carried out whenever each layer is formed. The laminate 4 can be produced by a smaller number of operation steps in the simultaneous firing method than in the sequential firing method. In addition, the laminate 4 produced by the simultaneous firing method becomes denser than the laminate 4 produced by the sequential firing method. Hereinafter, the case of using the simultaneous firing method will be described as an example.

First, individual materials of the positive electrode current collector layer 1A, the positive electrode active material layer 1B, the solid electrolyte layer 3, the negative electrode active material layer 2B and the negative electrode current collector layer 2A, which configure the laminate 4, are made into pastes. For the solid electrolyte layer 3, a material obtained by mixing the first compound 31 and the second compound 32 is made into a paste. Each of the first compound 31 and the second compound 32 can be produced by a solid-phase reaction method or the like. The average grain diameters Da and Db can be adjusted with the milling time of each of the first compound 31 and the second compound 32.

A method for making each material into a paste is not particularly limited, and, for example, a method in which the powder of each material is mixed into a vehicle to obtain a plate can be used. Here, the vehicle is a collective term for media in a liquid phase. The vehicle contains a solvent and a binder.

Next, green sheets are produced. The green sheets are obtained by applying the pastes produced from the individual materials on base materials such as polyethylene terephthalate (PET) films, drying the pastes as necessary, and peeling the base materials. A method for applying the paste is not particularly limited, and it is possible to use, for example, a well-known method such as screen printing, application, transfer or a doctor blade.

Next, the green sheets produced from the individual materials are stacked according to a desired order and the desired number of layers to be laminated, thereby producing laminated sheets. At the time of laminating the green sheets, alignment, cutting or the like is carried out as necessary. For example, in the case of producing a parallel type or serial-parallel type battery, individual green sheets are aligned so that the end faces of the positive electrode current collectors 1A and the end faces of the negative electrode current collectors 2A do not coincide with each other and stacked together.

The laminated sheets may be produced using a method in which a positive electrode unit and a negative electrode unit are produced and these units are laminated. The positive electrode unit is a laminated sheet in which the solid electrolyte layer 3, the positive electrode active material layer 1B, the positive electrode current collector layer 1A and the positive electrode active material layer 1B are laminated in this order. The negative electrode unit is a laminated sheet in which the solid electrolyte layer 3, the negative electrode active material layer 2B, the negative electrode current collector layer 2A and the negative electrode active material layer 2B are laminated in this order. The units are laminated so that the solid electrolyte layer 3 in the positive electrode unit and the negative electrode active material layer 2B in the negative electrode unit face each other or the positive electrode active material layer 1B in the positive electrode unit and the solid electrolyte layer 3 in the negative electrode unit face each other.

Next, the produced laminated sheets are collectively pressurized to enhance the adhesion of each layer. The pressurization can be carried out by, for example, mold pressing, hot water isostatic pressing (WIP), cold water isostatic pressing (CIP), isostatic pressing or the like. The pressurization is preferably carried out under heating. The heating temperature during pressure bonding is set to, for example, 40° C. to 95° C. Next, the pressurized laminate is cut using a dicing device and made into chips. In addition, a debinding treatment and firing are carried out on the chips, whereby the laminate 4 formed of a sintered body is obtained.

The debinding treatment can be carried out as a separate step from a firing step. When a debinding step is carried out, the binder component that is contained in the chips is heated and decomposed before the firing step, which makes it possible to suppress the rapid decomposition of the binder component in the firing step. The debinding step is carried out by, for example, heating the chips at a temperature of 300° C. to 800° C. for 0.1 to 10 hours in a nitrogen atmosphere. In the case of being carried out in a reducing atmosphere, the debinding step may be carried out in, for example, an argon atmosphere or a nitrogen/hydrogen-mixed atmosphere instead of the nitrogen atmosphere.

The firing step is carried out by, for example, placing the chips on a ceramic stand. Firing is carried out by, for example, heating the chips at 600° C. to 1000° C. in a nitrogen atmosphere. The firing time is set to, for example, 0.1 to three hours. In the case of being carried out in a reducing atmosphere, the firing step may be carried out in, for example, an argon atmosphere or a nitrogen/hydrogen-mixed atmosphere instead of the nitrogen atmosphere.

In addition, the sintered laminate 4 (sintered body) may be put into a cylindrical container together with a polishing agent such as alumina and may be barrel-polished. This makes it possible to chamfer the corners of the laminate. The polishing may be carried out using sandblasting. Sandblasting is capable of scraping only a specific portion, which is preferable.

The terminal electrodes 5 and 6 are formed on side surfaces of the produced laminate 4 that face each other. The terminal electrodes 5 and 6 can be each formed using a method such as a sputtering method, a dipping method, a screen-printing method or a spray coating method. The all-solid-state battery 10 can be produced by carrying out the steps as described above. In a case where the terminal electrodes 5 and 6 are formed only on specific portions, the above-described treatment is carried out with portions other than the specific portions masked with tape or the like.

The solid electrolyte layer 3 according to the present embodiment has the first compound 31 and the second compound 32, whereby the sinterability improves, and the cavities 33 are unlikely to be formed. The cavities 33 are likely to induce the intrusion of moisture or the like and are one cause for the deterioration of the solid electrolyte layer 3. The solid electrolyte layer 3 according to the present embodiment has a small number of the cavities 33 and is thereby unlikely to deteriorate under high-temperature and high-humidity environments. As a result, the all-solid-state battery 10 according to the present embodiment is excellent in terms of cycle characteristic at high temperatures and high humidity.

Hitherto, the embodiment of the present invention has been described in detail with reference to the drawings, but each configuration in each embodiment, a combination thereof and the like are examples, and the addition, omission, substitution and other modification of the configuration are possible within the scope of the gist of the present invention.

### EXAMPLES

### Example 1

LiZr₂(PO₄)₃ was prepared as a first compound (solid electrolyte), and ZrP₂O₇ was prepared as a second compound. In addition, each was milled and sieved for a predetermined time, thereby adjusting the grain diameters of each. The average grain diameter Da of the first compound was set to 1 m, and the average grain diameter Db of the second compound was set to 0.5 m. In addition, the first compound and the second compound were mixed together so that the volume % of the second compound reached 0.5 volume %.

Next, 100 parts of ethanol and 200 parts of toluene were added as solvents to 100 parts of the produced powder mixture and mixed in a wet manner with a ball mill. After that, 16 parts of a polyvinyl butyral-based binder as a binder and 4.8 parts of benzyl butyl phthalate as a plasticizer were injected thereinto and mixed therewith, thereby preparing a paste for a solid electrolyte layer. The paste for a solid electrolyte layer was molded into a sheet on a PET film as a base material by the doctor blade method, thereby obtaining a solid electrolyte layer sheet.

The thickness of the solid electrolyte layer sheet was set to 15 μm.

Next, a paste for a positive electrode active material layer and a paste for a negative electrode active material layer were produced. These pastes were produced by adding 15 parts of ethyl cellulose as a binder and 65 parts of dihydroterpineol as a solvent to 100 parts of a Li₃V₂(PO₄)₃ powder and mixing and dispersing the powder.

Next, a paste for a positive electrode current collector and a paste for a negative electrode current collector were produced. These pastes were produced by the following procedure. First, Cu was used as a current collector. In addition, Cu and Li₃V₂(PO₄)₃ were mixed together for the pastes such that the volume proportions reached 80:20. Next, 10 parts of ethyl cellulose as a binder and 50 parts of dihydroterpineol as a solvent were added to 100 parts of this powder to mix and disperse the powder, thereby producing the pastes.

Next, a positive electrode unit and a negative electrode unit were produced by the following procedure. First, the paste for a positive electrode active material was printed in a thickness of 5 m on the solid electrolyte layer sheet using screen printing. Next, the printed paste for a positive electrode active material was dried at 80° C. for five minutes. In addition, the paste for a current collector was printed in a thickness of 5 μm on the dried paste for a positive electrode active material using screen printing. Next, the printed paste for a positive electrode current collector was dried at 80° C. for five minutes. In addition, the paste for a positive electrode active material was printed again in a thickness of 5 m on the dried paste for a positive electrode current collector using screen printing and dried. After that, the PET film was peeled off. A positive electrode unit in which a positive electrode active material layer, a positive electrode current collector layer and a positive electrode active material layer were laminated in this order on the main surface of a solid electrolyte layer was obtained as described above.

In addition, a negative electrode unit in which a negative electrode active material layer, a negative electrode current collector layer and a negative electrode active material layer were laminated in this order on the main surface of a solid electrolyte layer was obtained by the same procedure.

A laminate was produced by overlapping five solid electrolyte layer sheets and alternately stacking 50 electrode units (25 positive electrode units and 25 negative electrode units) thereon with the solid electrolyte therebetween. At this time, the individual units were unevenly stacked such that the current collector layers of the n^{th} (n=odd number) electrode units extended up to only one end surface and the current collector layers of the nth (n=even number) electrode units extended up to only the other end surface. Six solid electrolyte layer sheets were stacked on these stacked units. After that, the stacked solid electrolyte layer sheets and the stacked units were molded by thermal compression bonding and then cut, thereby producing laminated chips. After that, the laminated chips were simultaneously fired to obtain a laminate. In the simultaneous firing, the temperature was raised up to a firing temperature of 800° C. at a temperature rising rate of 200° C./hour in a nitrogen atmosphere, and the laminated chips were held at the firing temperature for two hours and naturally cooled after firing.

In addition, a cross section that had appeared by cutting the fired laminate with a cross section polisher (CP) parallel to the lamination direction was analyzed with SEM and EDS, and the average grain diameter of each of the first compound and the second compound was obtained. The average grain diameter Da of the first compound and the average grain diameter Db of the second compound did not significantly change from those at the time of the production of the pastes, the average grain diameter Da of the first compound was 1 μm, and the average grain diameter Db of the second compound was 0.5 μm. Therefore, the ratio between the average grain diameter Da of the first compound and the average grain diameter Db of the second compound was Da/Db=2.0.

In addition, a first external terminal and a second external terminal were attached to the sintered laminate (sintered body) by a well-known method, thereby producing an all-solid-state battery.

In addition, the cycle characteristic of the produced all-solid-state battery was measured. The cycle characteristic was performed by sandwiching the first external terminal and the second external terminal so as to face each other with spring probes and repeating a charge and discharge test under conditions of a temperature of 40° C. and a humidity of 93%. Regarding the measurement conditions, the currents during charging and discharging were both set to 20 μA, and the final voltages during charging and discharging were each set to 1.6 V or 0 V.

The cycle characteristic in Example 1 was 60%. The capacity at the time of first discharging was regarded as the initial discharge capacity. In addition, the cycle characteristic was obtained by dividing the discharge capacity at the 100^{th} cycle by the initial discharge capacity.

### Examples 2 to 10, Comparative Example 1 and Comparative Example 2

Examples 2 to 10, Comparative Example 1 and Comparative Example 2 were different from Example 1 in that the mixing ratios between the first compound and the second compound were different. As a result, in Examples 2 to 10, Comparative Example 1 and Comparative Example 2, the abundances ratio of the second compound in the solid electrolyte layer were different from that in Example 1. The other conditions were set to be the same as in Example 1, and cycle characteristics in high-temperature and high-humidity environments were obtained. The results are summarized in Table 1 below.

TABLE 1

| | | | Abundance ratio | | | | Cycle characteristic under |
|---|---|---|---|---|---|---|---|
| | | | of second | | | | high-temperature and high- |
| | First | Second | compound | Da | Db | Da/ | humidity environment |
| | compound | compound | [volume %] | (μm) | (μm) | Db | [%] |
| Example 1 | LiZr₂(PO₄)₃ | ZrP₂O₇ | 0.5 | 1.0 | 0.5 | 2.0 | 60 |
| Example 2 | LiZr₂(PO₄)₃ | ZrP₂O₇ | 1.0 | 1.0 | 0.5 | 2.0 | 67 |
| Example 3 | LiZr₂(PO₄)₃ | ZrP₂O₇ | 2.0 | 1.0 | 0.5 | 2.0 | 80 |
| Example 4 | LiZr₂(PO₄)₃ | ZrP₂O₇ | 3.0 | 1.0 | 0.5 | 2.0 | 35 |
| Example 5 | LiZr₂(PO₄)₃ | ZrP₂O₇ | 3.5 | 1.0 | 0.5 | 2.0 | 88 |
| Example 6 | LiZr₂(PO₄)₃ | ZrP₂O₇ | 4.0 | 1.0 | 0.5 | 2.0 | 86 |
| Example 7 | LiZr₂(PO₄)₃ | ZrP₂O₇ | 5.0 | 1.0 | 0.5 | 2.0 | 83 |
| Example 8 | LiZr₂(PO₄)₃ | ZrP₂O₇ | 6.0 | 1.0 | 0.5 | 2.0 | 75 |
| Example 9 | LiZr₂(PO₄)₃ | ZrP₂O₇ | 8.0 | 1.0 | 0.5 | 2.0 | 71 |
| Example 10 | LiZr₂(PO₄)₃ | ZrP₂O₇ | 9.0 | 1.0 | 0.5 | 2.0 | 63 |
| Comparative | LiZr₂(PO₄)₃ | ZrP₂O₇ | 0.2 | 1.0 | 0.5 | 2.0 | 40 |
| Example 1 | | | | | | | |
| Comparative | LiZr₂(PO₄)₃ | ZrP₂O₇ | 10 | 1.0 | 0.5 | 2.0 | 42 |
| Example 2 | | | | | | | |

In Examples 1 to 10 where the abundances ratio of the second compound were 0.5 volume % or more and less than 10 volume %, the cycle characteristics were superior to those in Comparative Example 1 and Comparative Example 2 where the abundances ratio were not in the range.

### Examples 11 to 20, Comparative Examples 3 and 4

A difference from Example 1 is that LiTi₂(PO₄)₃ was used as the first compound (solid electrolyte) and TiP₂O₇ was used as the second compound. The mixing ratios between the first compound and the second compound were changed, and cycle characteristics in high-temperature and high-humidity environments were obtained. The results are summarized in Table 2 below.

TABLE 2

| | | | Abundance ratio | | | | Cycle characteristic under |
|---|---|---|---|---|---|---|---|
| | | | of second | | | | high-temperature and high- |
| | First | Second | compound | Da | Db | Da/ | humidity environment |
| | compound | compound | [volume %] | (μm) | (μm) | Db | [%] |
| Example 11 | LiTi₂(PO₄)₃ | TiP₂O₇ | 0.5 | 1.0 | 0.5 | 2.0 | 62 |
| Example 12 | LiTi₂(PO₄)₃ | TiP₂O₇ | 1.0 | 1.0 | 0.5 | 2.0 | 65 |
| Example 13 | LiTi₂(PO₄)₃ | TiP₂O₇ | 2.0 | 1.0 | 0.5 | 2.0 | 71 |
| Example 14 | LiTi₂(PO₄)₃ | TiP₂O₇ | 3.0 | 1.0 | 0.5 | 2.0 | 74 |
| Example 15 | LiTi₂(PO₄)₃ | TiP₂O₇ | 3.5 | 1.0 | 0.5 | 2.0 | 77 |
| Example 16 | LiTi₂(PO₄)₃ | TiP₂O₇ | 4.0 | 1.0 | 0.5 | 2.0 | 75 |
| Example 17 | LiTi₂(PO₄)₃ | TiP₂O₇ | 5.0 | 1.0 | 0.5 | 2.0 | 72 |
| Example 18 | LiTi₂(PO₄)₃ | TiP₂O₇ | 6.0 | 1.0 | 0.5 | 2.0 | 68 |
| Example 19 | LiTi₂(PO₄)₃ | TiP₂O₇ | 8.0 | 1.0 | 0.5 | 2.0 | 65 |
| Example 20 | LiTi₂(PO₄)₃ | TiP₂O₇ | 9.0 | 1.0 | 0.5 | 2.0 | 61 |
| Comparative | LiTi₂(PO₄)₃ | TiP₂O₇ | 0.2 | 1.0 | 0.5 | 2.0 | 41 |
| Example 3 | | | | | | | |
| Comparative | LiTi₂(PO₄)₃ | TiP₂O₇ | 10 | 1.0 | 0.5 | 2.0 | 44 |
| Example 4 | | | | | | | |

Even in Examples 11 to 20, Comparative Examples 3 and 4 where Zr was changed to Ti, there were the same tendency as in Examples 1 to 10, Comparative Example 1 and Comparative Example 2.

### Examples 21 to 30, Comparative Examples 5 and 6

A difference from Example 1 is that LiZr_{1.5}Ti_{0.5}(PO₄)₃ was used as the first compound (solid electrolyte) and Zr_{0.75}Ti_{0.25}P₂O₇ was used as the second compound. The mixing ratios between the first compound and the second compound were changed, and cycle characteristics in high-temperature and high-humidity environments were obtained. The results are summarized in Table 3 below.

TABLE 3

| | | | Abundance ratio | | | | Cycle characteristic under |
|---|---|---|---|---|---|---|---|
| | | | of second | | | | high-temperature and high- |
| | | | compound | Da | Db | Da/ | humidity environment |
| | First compound | Second compound | [volume %] | (μm) | (μm) | Db | [%] |
| Example 21 | LiₐZr_{1.5}Ti_{0.5}(PO₄)₃ | Zr_{0.75}Ti_{0.25}P₂O₇ | 0.5 | 1.0 | 0.5 | 2.0 | 64 |
| Example 22 | LiₐZr_{1.5}Ti_{0.5}(PO₄)₃ | Zr_{0.75}Ti_{0.25}P₂O₇ | 1 | 1.0 | 0.5 | 2.0 | 68 |
| Example 23 | LiₐZr_{1.5}Ti_{0.5}(PO₄)₃ | Zr_{0.75}Ti_{0.25}P₂O₇ | 2 | 1.0 | 0.5 | 2.0 | 73 |
| Example 24 | LiₐZr_{1.5}Ti_{0.5}(PO₄)₃ | Zr_{0.75}Ti_{0.25}P₂O₇ | 3 | 1.0 | 0.5 | 2.0 | 76 |
| Example 25 | LiₐZr_{1.5}Ti_{0.5}(PO₄)₃ | Zr_{0.75}Ti_{0.25}P₂O₇ | 3.5 | 1.0 | 0.5 | 2.0 | 80 |
| Example 26 | LiₐZr_{1.5}Ti_{0.5}(PO₄)₃ | Zr_{0.75}Ti_{0.25}P₂O₇ | 4 | 1.0 | 0.5 | 2.0 | 78 |
| Example 27 | LiₐZr_{1.5}Ti_{0.5}(PO₄)₃ | Zr_{0.75}Ti_{0.25}P₂O₇ | 5 | 1.0 | 0.5 | 2.0 | 75 |
| Example 28 | LiₐZr_{1.5}Ti_{0.5}(PO₄)₃ | Zr_{0.75}Ti_{0.25}P₂O₇ | 6 | 1.0 | 0.5 | 2.0 | 69 |
| Example 29 | LiₐZr_{1.5}Ti_{0.5}(PO₄)₃ | Zr_{0.75}Ti_{0.25}P₂O₇ | 8 | 1.0 | 0.5 | 2.0 | 68 |
| Example 30 | LiₐZr_{1.5}Ti_{0.5}(PO₄)₃ | Zr_{0.75}Ti_{0.25}P₂O₇ | 9 | 1.0 | 0.5 | 2.0 | 62 |
| Comparative | LiₐZr_{1.5}Ti_{0.5}(PO₄)₃ | Zr_{0.75}Ti_{0.25}P₂O₇ | 0.2 | 1.0 | 0.5 | 2.0 | 43 |
| Example 5 | | | | | | | |
| Comparative | LiₐZr_{1.5}Ti_{0.5}(PO₄)₃ | Zr_{0.75}Ti_{0.25}P₂O₇ | 10 | 1.0 | 0.5 | 2.0 | 41 |
| Example 6 | | | | | | | |

Even in Examples 21 to 30, Comparative Examples 5 and 6 where some of Zr was substituted into Ti, there were the same tendency as in Examples 1 to 10, Comparative Example 1 and Comparative Example 2.

### Examples 31 to 41

Examples 31 to 41 are different from Example 5 in that the average grain diameters of the second compound were changed. In association with the changes in the average grain diameters of the second compound, the values of Da/Db obtained by dividing the average grain diameter Da of the first compound by the average grain diameter Db of the second compound also differed. A cycle characteristic in a high-temperature and high-humidity environment in each of Examples 31 to 41 was obtained. The results are summarized in Table 4 below.

TABLE 4

| | | | Abundance ratio | | | | Cycle characteristic under |
|---|---|---|---|---|---|---|---|
| | | | of second | | | | high-temperature and high- |
| | First | Second | compound | Da | Db | Da/ | humidity environment |
| | compound | compound | [volume %] | (μm) | (μm) | Db | [%] |
| Example 31 | LiZr₂(PO₄)₃ | ZrP₂O₇ | 3.5 | 1.0 | 12.5 | 0.08 | 68 |
| Example 32 | LiZr₂(PO₄)₃ | ZrP₂O₇ | 3.5 | 1.0 | 10.0 | 0.1 | 73 |
| Example 33 | LiZr₂(PO₄)₃ | ZrP₂O₇ | 3.5 | 1.0 | 2.0 | 0.5 | 78 |
| Example 34 | LiZr₂(PO₄)₃ | ZrP₂O₇ | 3.5 | 1.0 | 1.0 | 1.0 | 80 |
| Example 35 | LiZr₂(PO₄)₃ | ZrP₂O₇ | 3.5 | 1.0 | 0.67 | 1.5 | 84 |
| Example 5 | LiZr₂(PO₄)₃ | ZrP₂O₇ | 3.5 | 1.0 | 0.5 | 2.0 | 87 |
| Example 36 | LiZr₂(PO₄)₃ | ZrP₂O₇ | 3.5 | 1.0 | 0.4 | 2.5 | 86 |
| Example 37 | LiZr₂(PO₄)₃ | ZrP₂O₇ | 3.5 | 1.0 | 0.33 | 3.0 | 82 |
| Example 38 | LiZr₂(PO₄)₃ | ZrP₂O₇ | 3.5 | 1.0 | 0.2 | 5.0 | 78 |
| Example 39 | LiZr₂(PO₄)₃ | ZrP₂O₇ | 3.5 | 1.0 | 0.1 | 10.0 | 70 |
| Example 40 | LiZr₂(PO₄)₃ | ZrP₂O₇ | 3.5 | 1.0 | 0.05 | 20.0 | 66 |
| Example 41 | LiZr₂(PO₄)₃ | ZrP₂O₇ | 3.5 | 1.0 | 0.04 | 25.0 | 60 |

### Examples 42 to 54

Examples 42 to 54 are different from Example 5 in that Da/Db obtained by dividing the average grain diameter Da of the first compound by the average grain diameter Db of the second compound was fixed to 5.0 and the average grain diameters of the first compound and the second compound were changed. A cycle characteristic in a high-temperature and high-humidity environment in each of Examples 42 to 54 was obtained. The results are summarized in Table 5 below.

TABLE 5

| | | | Abundance ratio | | | | Cycle characteristic under |
|---|---|---|---|---|---|---|---|
| | | | of second | | | | high-temperature and high- |
| | First | Second | compound | Da | Db | Da/ | humidity environment |
| | compound | compound | [volume %] | (μm) | (μm) | Db | [%] |
| Example 42 | LiZr₂(PO₄)₃ | ZrP₂O₇ | 3.5 | 0.025 | 0.005 | 5.0 | 58 |
| Example 43 | LiZr₂(PO₄)₃ | ZrP₂O₇ | 3.5 | 0.05 | 0.0 | 5.0 | 62 |
| Example 44 | LiZr₂(PO₄)₃ | ZrP₂O₇ | 3.5 | 0.5 | 0.41 | 5.0 | 71 |
| Example 45 | LiZr₂(PO₄)₃ | ZrP₂O₇ | 3.5 | 1.5 | 0.3 | 5.0 | 80 |
| Example 46 | LiZr₂(PO₄)₃ | ZrP₂O₇ | 3.5 | 2.5 | 0.5 | 5.0 | 82 |
| Example 47 | LiZr₂(PO₄)₃ | ZrP₂O₇ | 3.5 | 4.0 | 0.8 | 5.0 | 81 |
| Example 48 | LiZr₂(PO₄)₃ | ZrP₂O₇ | 3.5 | 5.0 | 1.0 | 5.0 | 80 |
| Example 49 | LiZr₂(PO₄)₃ | ZrP₂O₇ | 3.5 | 7.5 | 1.5 | 5.0 | 76 |
| Example 50 | LiZr₂(PO₄)₃ | ZrP₂O₇ | 3.5 | 10.0 | 2.0 | 5.0 | 73 |
| Example 51 | LiZr₂(PO₄)₃ | ZrP₂O₇ | 3.5 | 15.0 | 3.0 | 5.0 | 68 |
| Example 52 | LiZr₂(PO₄)₃ | ZrP₂O₇ | 3.5 | 25.0 | 5.0 | 5.0 | 64 |
| Example 53 | LiZr₂(PO₄)₃ | ZrP₂O₇ | 3.5 | 50.0 | 10.0 | 5.0 | 61 |
| Example 54 | LiZr₂(PO₄)₃ | ZrP₂O₇ | 3.5 | 75.0 | 15.0 | 5.0 | 57 |

### REFERENCE SIGNS LIST

1 Positive electrode
1A Positive electrode current collector
1B Positive electrode active material layer
2 Negative electrode
2A Negative electrode current collector
2B Negative electrode active material layer
3 Solid electrolyte layer
4 Laminate
5, 6 Terminal electrode
10 All-solid-state battery
31 First compound
32 Second compound
33 Cavity

1. A solid electrolyte layer comprising:
a first compound represented by LiₐM₂(PO₄)₃ . . . (1); and
a second compound represented by M′P₂O₇ . . . (2),
wherein, in the first compound, a satisfies 0.9≤a≤1.4, M is one or more elements selected from the group consisting of Zr, Ti, Ge, Al, Hf, Ca, Ba, Sr, Sc, Y and In,
in the second compound, M′ is one or more elements selected from the group consisting of Zr, Ti, Ge, Al, Hf, Ca, Ba, Sr, Sc, Y and In, and
an abundance ratio of the second compound is 0.5 volume % or more and less than 10 volume %.

2. The solid electrolyte layer according to claim 1,
wherein an average grain diameter Da of the first compound and an average grain diameter Db of the second compound satisfy 0.1≤Da/Db≤20.0.

3. The solid electrolyte layer according to claim 1,
wherein the average grain diameter Db of the second compound satisfies 0.01 μm≤Db≤10 μm.

4. An all-solid-state battery comprising:
the solid electrolyte layer according to claim 1;
a positive electrode; and
a negative electrode, the positive electrode and the negative electrode sandwiching the solid electrolyte layer.
